(19) United States
(12) Patent Application Publication
(10) Pub. No.: US 2005/0138314 A1
(43) Pub. Date: Jun. 23, 2005

(54) Write-protected micro memory device

(76) Inventors: Ming-Jen Liang, Hsinchu Hsien (TW); Soo-Ching Ng, Hsinchu Hsien (TW)

Correspondence Address: BIRCH STEWART KOLASCH & BIRCH, PO BOX 747, FALLS CHURCH, VA, 22040-0747, US

(21) Appl. No.: 10/743,144

(22) Filed: Dec. 23, 2003

(51) Int. Cl. G06F 12/14

(52) U.S. Cl. 711/163; 711/103; 711/202

(57) ABSTRACT

The write-protected micro memory device of the present invention comprises at least one flash memory that is divided into one or multiple blocks, and the single chip flash memory controller has a write-protected parameter. The write-protect parameter can be set particularly for protecting data of certain block(s) of the flash memory. The memory device is connected to a host, such as a computer or card reader, through an interface circuit, to enable the host to retrieve data or program from the flash memory. The single chip flash memory controller prohibits the host to store or write data into the write-protected block(s) according to the preset write-protect parameter. Accordingly, the present invention do not require altering of the hardware structure or circuit connection of the memory device, but rather merely proposes to set up the write-protect parameter into the single chip flash memory controller to mark any block for substantially protecting the data or program therein.

### BACKGROUND OF THE INVENTION

1. The Field of the Invention

The present invention relates to a write-protected micro memory device, and more particularly to a single chip flash memory controller device having a write-protect parameter, wherein the write-protective parameter can be written to write-protect one of the blocks of the flash memory controller device disabling the host to write data or program into the write-protected block, and therefore this allows a user can assign any block as write-protected block by setting the write-protect parameter in a single chip flash memory controller device.

2. Description of the Related Art

Nowadays the technology in the electronic industry is being developed and has become more and more advanced. Apparently, an outrageous improvement has been made comparing the latest electronic products with the conventional ones, for example, computers, card readers, digital cameras, digital video cameras, mobile phones and PDA. The sizes of the electronic products are developed to be smaller than usual for providing the convenience of portability, and the data storage element applied therein has to be correspondingly smaller. Manufacturers of the electronic storage element have developed memory cards with various specification, for instance, CF, SD, SM, MS, MMC and other memory cards, to increase the memory capacity from the conventional million bits (Mb) to the latest million bytes (MB) in the same memory card size, the capacity has been increased up to more than billion bytes (1 GB) and still being continuously upgraded.

The memory card is applied in electronic products for many different purposes, for example, for storing personal data extended to digital key, the replacement of the disk driver for operating the computer system or as data storage device for mobile phone. Regardless of the requirements of the user or the system designer, a write-protect function is essential for protecting the stored files, data or programs. The conventional way to protect the data in the memory card is to lock the switch of the hardware, and connect one of the controlling terminals of the control chip of the memory chip to the switch for detecting the connecting signal status (on or off) of the switch to decide whether to protect from writing. Such method not only increases the manufacturing cost of hardware but also this technique cannot provide write-protect for a particular block for a flash memory having several blocks.

### SUMMARY OF THE INVENTION

Accordingly, in the view of the foregoing, the present inventor makes a detailed study of related art to evaluate and consider, and uses years of accumulated experience in this field, and through several experiments, to create a new flash memory controller having write-protect parameter. The present invention provides an innovated cost effective flash memory controller having write-protect parameter.

According to an aspect of the present invention, the flash memory of the memory device is divided into one or multiple blocks, and the single chip flash memory controller has a write-protected parameter. The write-protect parameter can be set particularly for protecting data of certain block(s) of the flash memory. The memory device is connected to a host, such as a computer or card reader, through an interface circuit, to enable the host to retrieve data or program from the flash memory. The single chip flash memory controller prevents the host to store or write data into the write-protected block(s) according to the preset write-protect parameter. Accordingly, the present invention do not require any modification of the hardware structure or circuit connection of the memory device, but rather merely proposes to set up the write-protect parameter into the single chip flash memory controller to mark any block for substantially protecting the data or program therein.

### BRIEF DESCRIPTION OF THE DRAWING

For a more complete understanding of the present invention, reference will now be made to the following detailed description of preferred embodiments taken in conjunction with the following accompanying drawings.

FIG. 1 is a view of a block lay out of the circuit of the write-protected micro memory device of the present invention.

FIG. 2 is the writing time-line/sequential chart of the write-protected micro memory device of the present invention.

FIG. 3 is a usual writing control procedure of the write-protected micro memory device of the present invention.

FIG. 4 is a prospective view of a structure of a single chip flash memory controller of the present invention.

FIG. 5 is a block lay out of the write-protected flash micro memory of the present invention.

FIG. 6 is the writing proof procedure of the present invention.

FIG. 7 is a view showing the internal aspect of the single chip flash memory controller of the present invention.

FIG. 8 is a circuit layout of the write-protected micro memory device according to another preferred embodiment of the present invention.

FIG. 9 is a view of the memory block according to another preferred embodiment of the present invention.

FIG. 10 is a view illustrating writing into the protected data storage block according to another preferred embodiment of the present invention.

FIG. 11 is a view illustrating the procedure of executing the usual writing according to another preferred embodiment of the present invention.

FIG. 12 is a write-protecting procedure according to another preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

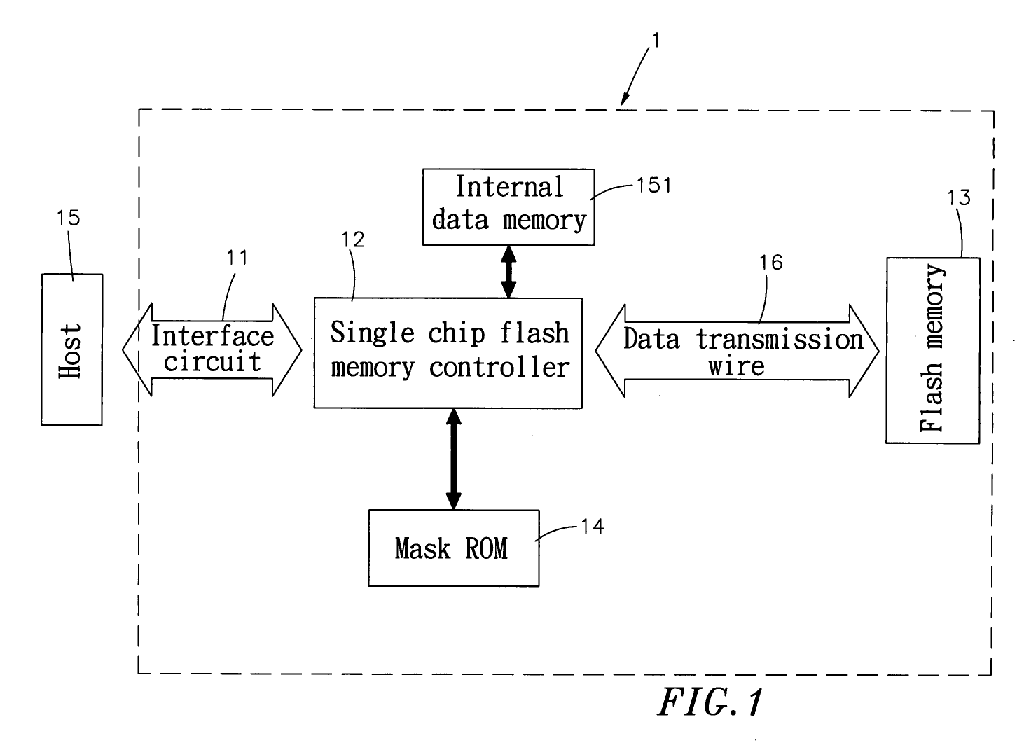

The present invention provides a write-protected micro memory device. Referring to FIG. 1, the memory device 1, for example, the memory card, memory stick and so on, comprises an interface circuit 11, a single chip flash memory controller 12, and at least one flash memory 13. The flash memory 13 is one to several blocks. The single chip flash memory controller 12 has a parameter set for protecting from writing into certain blocks in the flash memory 13. The interface circuit 11 is conjoint to a host 15 for enabling the host 15 to retrieve/store data or program from/to the flash memory 13. The single chip flash memory controller 12 can prevent the host 15 to write data into some certain blocks in the flash memory 13 according to the preset parameter.

Furthermore, the single chip flash memory controller 12 is a programmable firmware, which can be inlayed in or external to a mask ROM 14, which can burn (record) the program (or data) once to enable the user to set a write-protect parameter in the mask ROM 14, and the parameter is capable of write-protecting certain blocks of the flash memory 13.

As depicted above, the single chip flash memory controller 12 is a programmable firmware, which is inlayed in or external to the mask ROM 14, which can burn the program (or data) multiple times, such as EEPROM or Nor Type Flash, allowing the user to set a write-protect parameter in the mask ROM 14, and the write-protect parameter is capable of preventing certain blocks from being written and thereby protect the data or program therein.

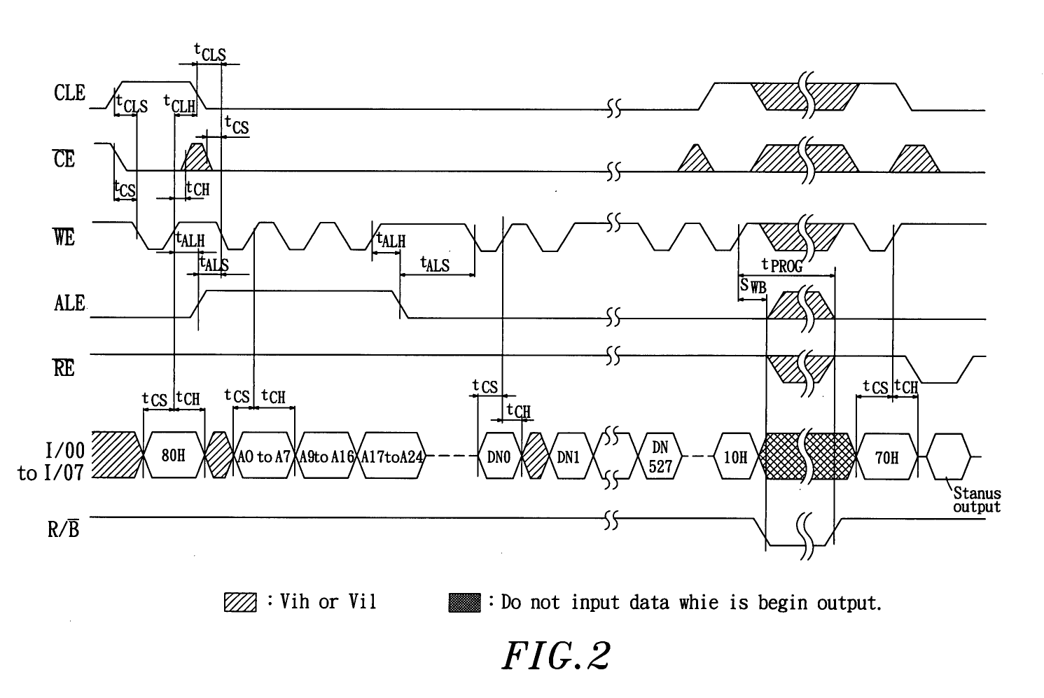

Now referring to FIGS. 1 and 2, the single chip flash memory controller 12 converts the control signal of the host 15 into a signal for controlling the flash memory 13, and also to manage and properly program the flash memory 13 to enable the single chip flash memory controller 12 receive the command from the host 15 (including writing address and data), and send out the writing command to the flash memory 13, then write the address and data transmitted from the host 15 in an orderly manner into the flash memory 13 (as shown in FIG. 2, in the form of the writing time-line/sequential chart).

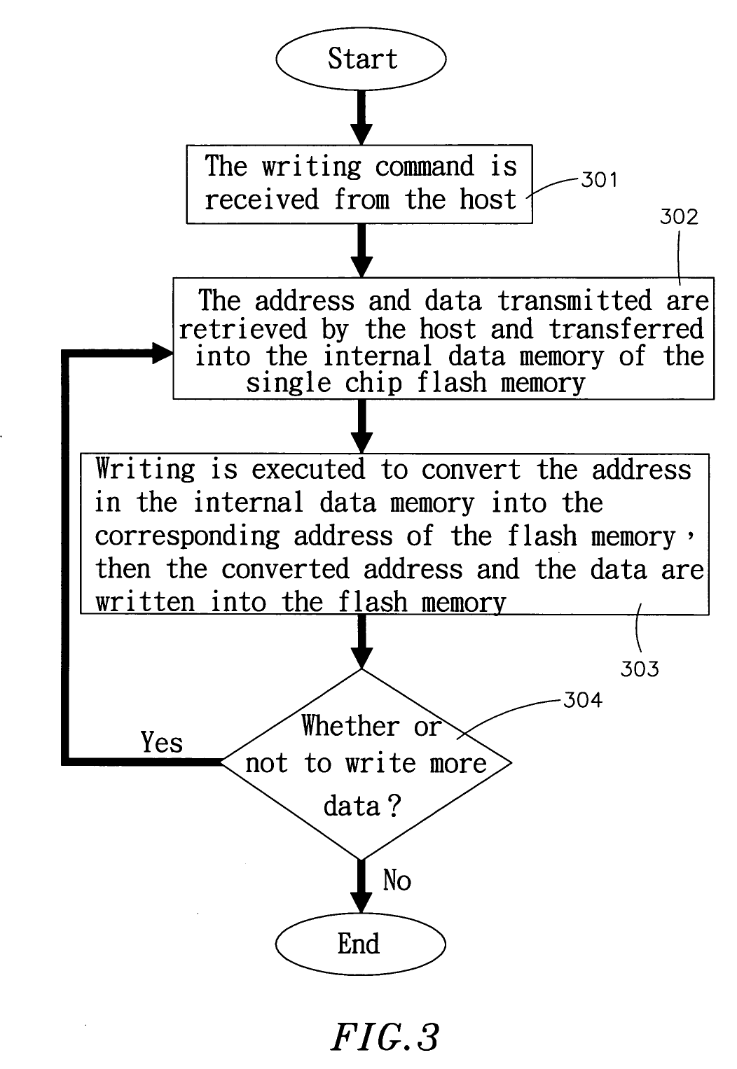

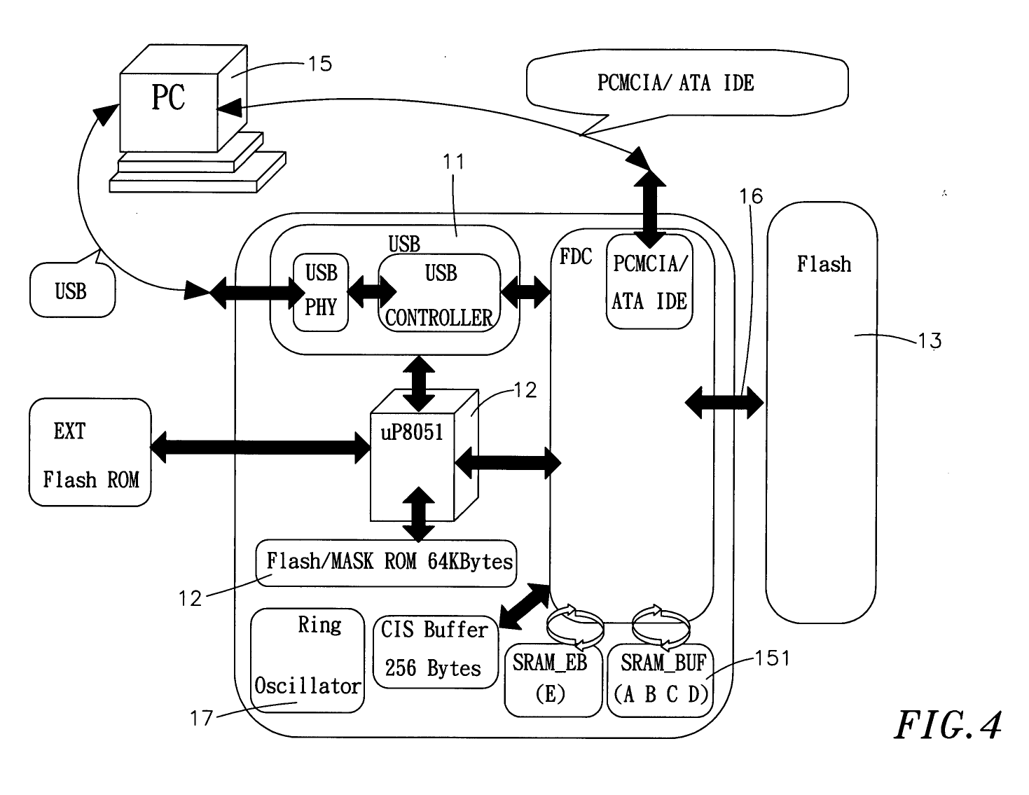

Referring to FIGS. 1 and 4, the memory device 1 receives the writing command from the host 15 through the interface circuit 11, then transmits the command back to the single chip flash memory controller 12 (for example: 8051 controller) for decoding the command, meanwhile, retrieves the data according to the host 15 writing commands and store into the internal data memory 151 of the single chip flash memory controller 12. After the single chip flash memory controller 12 finish decoding the command, the data is written into the flash memory 13 through the data transmission wire 16, which is connected to the flash memory 13. Additionally, the shaker 17 is the clock for the system operation. Referring to FIG. 3, when the memory device 1 processes the data writing command, the procedure of the single chip flash memory controller 12 is described as follows:
the writing command is received from the host 15 (step 301);
the address and data transmitted are retrieved by the host 15 and transferred into the internal data memory 151 of the single chip flash memory controller 12 (step 302);
writing action is executed to convert the address in the internal data memory 151 into the corresponding address of the flash memory 13, then the converted address and the data are written into the flash memory 13 (step 303); and
whether or not to write is judged (step 304), if yes, then the procedure will proceed to step (302), if no, then the procedure ends.

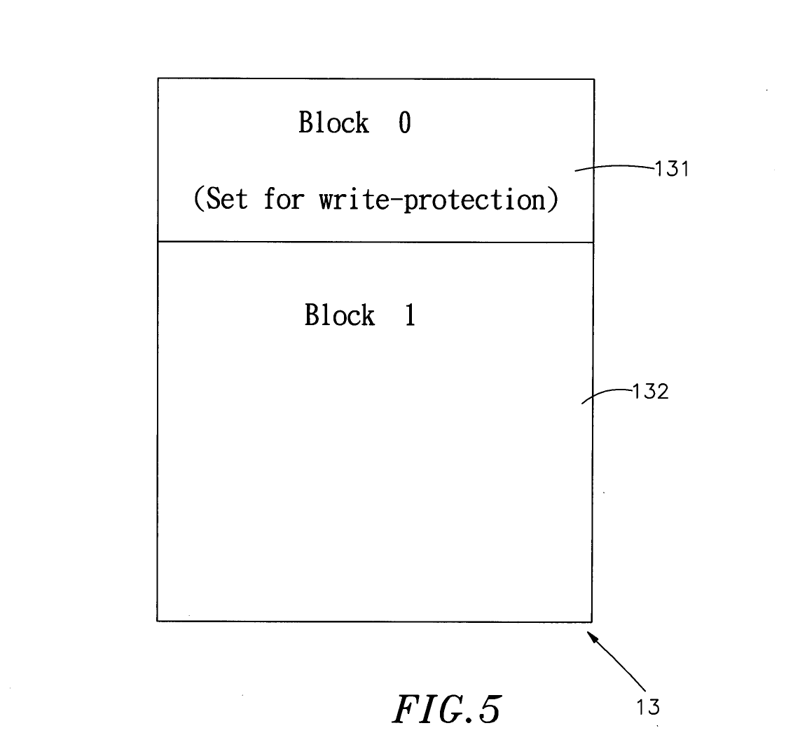

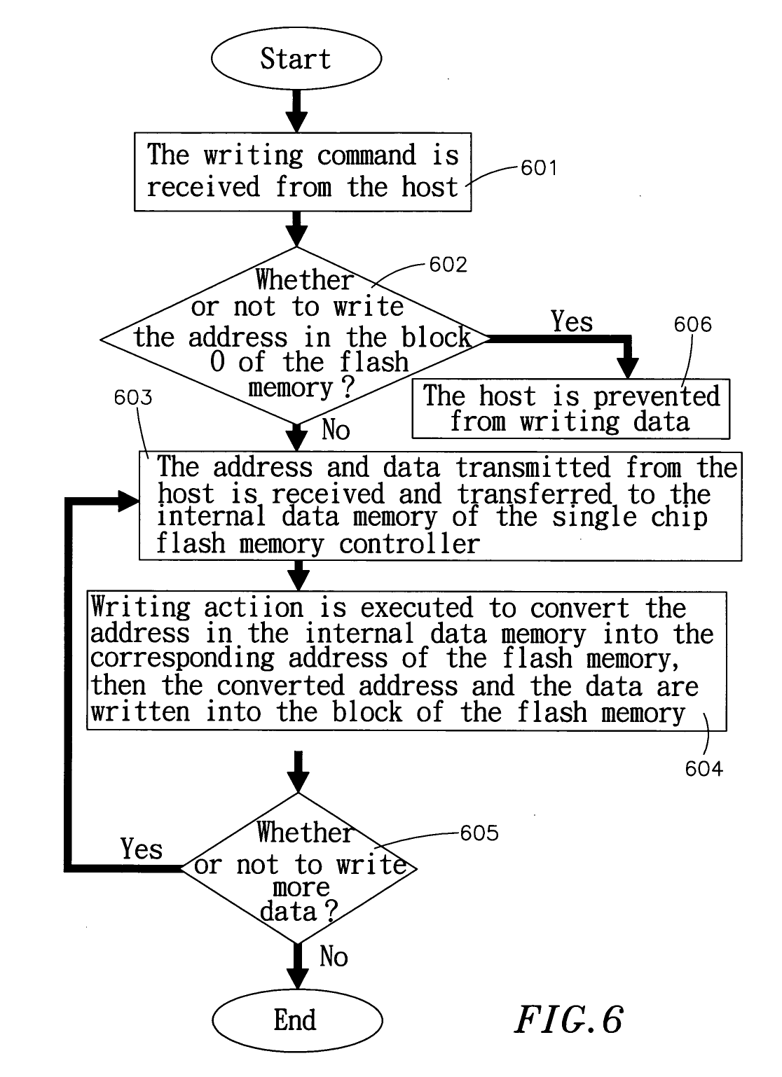

Further referring to FIG. 5, the write-protect parameter including the write-protection to the block 0 131 of the upper part of the flash memory 13 and the block 1 132 of the lower part of the flash memory 13 without the write-protection are shown. Now referring to both FIGS. 5 and 6, when the host 15 stores/retrieves data or program to/from the flash memory 13, the procedure of the single chip flash memory controller 12 is described as follows:
the writing command is received from the host 15 (step 601);
judging whether or not to write the address in the block 0 131 of the flash memory 13 is judged (step 602), if yes, then the procedure will proceed to step (606), if not, the procedure proceeds to the step (603);
the address and data transmitted from the host 15 is received and transferred to the internal data memory 151 of the single chip flash memory controller 12 (step 603);
writing action is executed to convert the address in the internal data memory 151 into the corresponding address of the flash memory 13, then the converted address and the data are written into the block 1 132 of the flash memory 13 (step 604);
whether or not to write more data is judged (step 605), if yes, then the procedure will proceed to step (603), if not, the procedure ends; and
the host 15 is prevented from writing data into the block 0 131 in response to the host 15 (606).

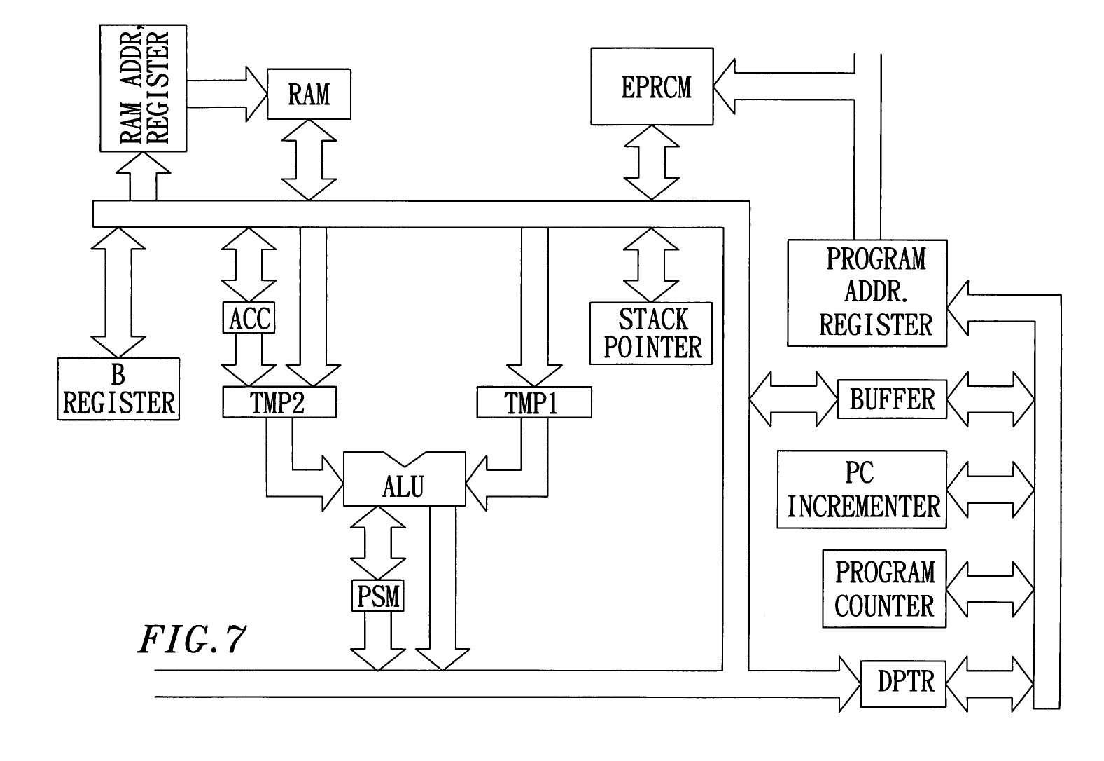

Furthermore, referring to FIG. 7, the internal aspect of the single chip flash memory controller of the present invention is shown, wherein the additional firmware program is for judging whether the address that the host 15 going to write is the address of the block 0 131, and the procedure of the single chip flash memory controller 12 includes: reading out the address of the block 0 131 from the program memory and storing this address temporarily into TMP2 data memory through the internal Bus, and the address transmitted from the host 15 will be stored into TMP1 data memory through the internal Bus; comparing whether the above two addresses are the same by ALU calculation comparator, wherein if they are same, then the host 15 will process writing into the block 0 131 and then reads out the processing procedure of the write-protect parameter from the program memory and responds to the host 15 write-protection signal; if they are different, then the host 15 will not write into the block 0 131, which is write-protected, instead, the host 15 writes into unprotected block 1 132, then retrieves the processing procedure of the flash memory 13 from the program memory for executing the writing command of the host 15.

Accordingly, with the single chip flash memory controller 12 of the present invention, modification of the hardware structure or circuit connection of the memory device 1 is not required, but rather by merely setting up or renewing the write-protect parameter into the single chip flash memory controller 12 to mark any block, the data or program therein can be substantially protected.

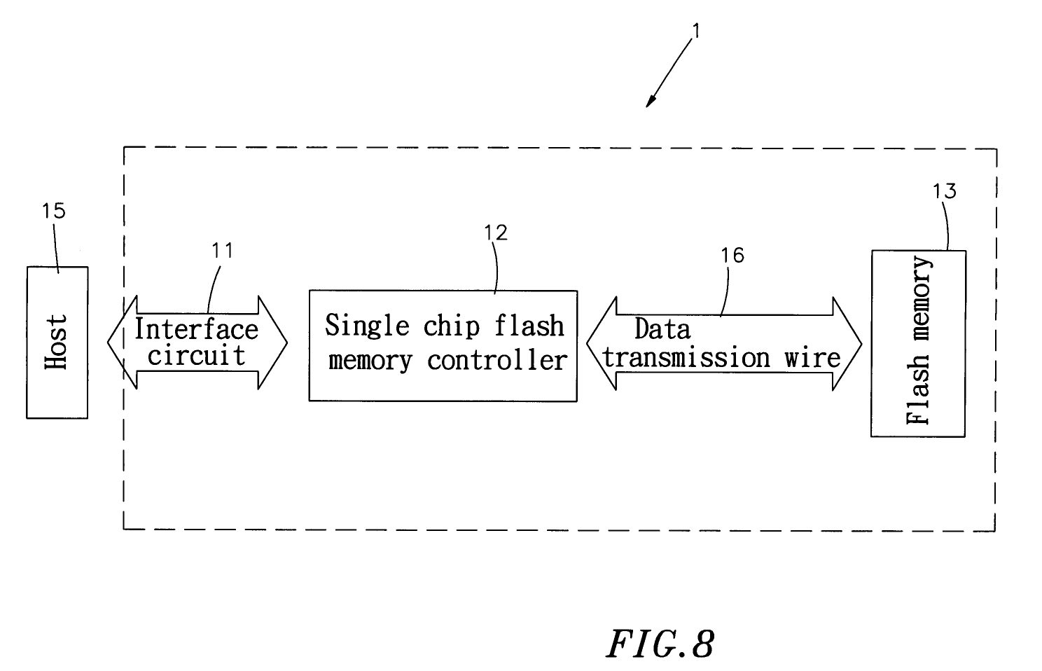

The present invention provides another embodiment of the write-protected micro memory device. Referring to FIG. 8, the memory device 1, for example, memory chard, memory stick and alike, comprises a interface circuit 11, a single chip flash memory controller 12 and at least one flash memory 13, wherein the single chip flash memory controller 12 is joint to the interface circuit 11 and the flash memory 13 respectively. The flash memory 13 is divided into one or multiple blocks, wherein a redundant block has a write-protect parameter. The write-protect parameter provides write-protection particularly for one of the blocks of the flash memory 13. The above interface circuit 11 is connected to a host 15, such as a computer or card reader. When the host 15 stores/retrieves data or program to/from the flash memory 13, the single chip flash memory controller 12 can prevent the host 15 to store/retrieve to/from the block, which is marked with write-protect in the flash memory 13, according to the write-protect parameter set in the block there within.

Furthermore, except for storing the logic address, the redundant block has a remaining area of which hasn't been marked for the purpose, so that the active parameter of the write-protect can be stored into the unmarked block to enable the host 15 to read the active parameter for judging whether the block has write-protection each time before writing data into the block and then decides the further steps to execute.

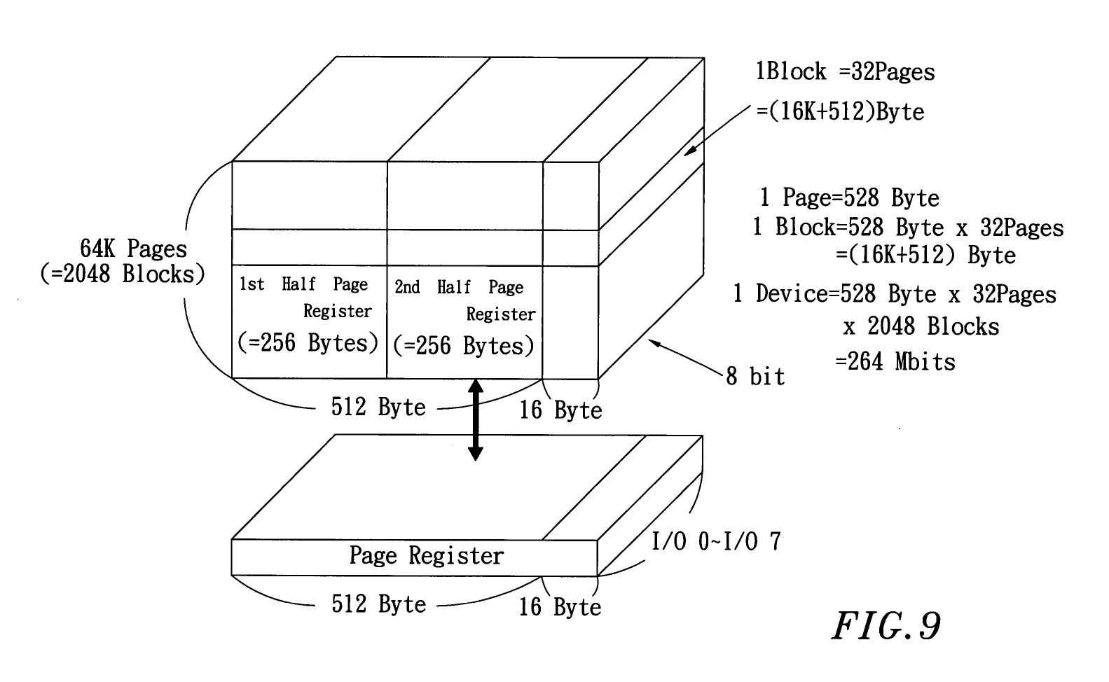

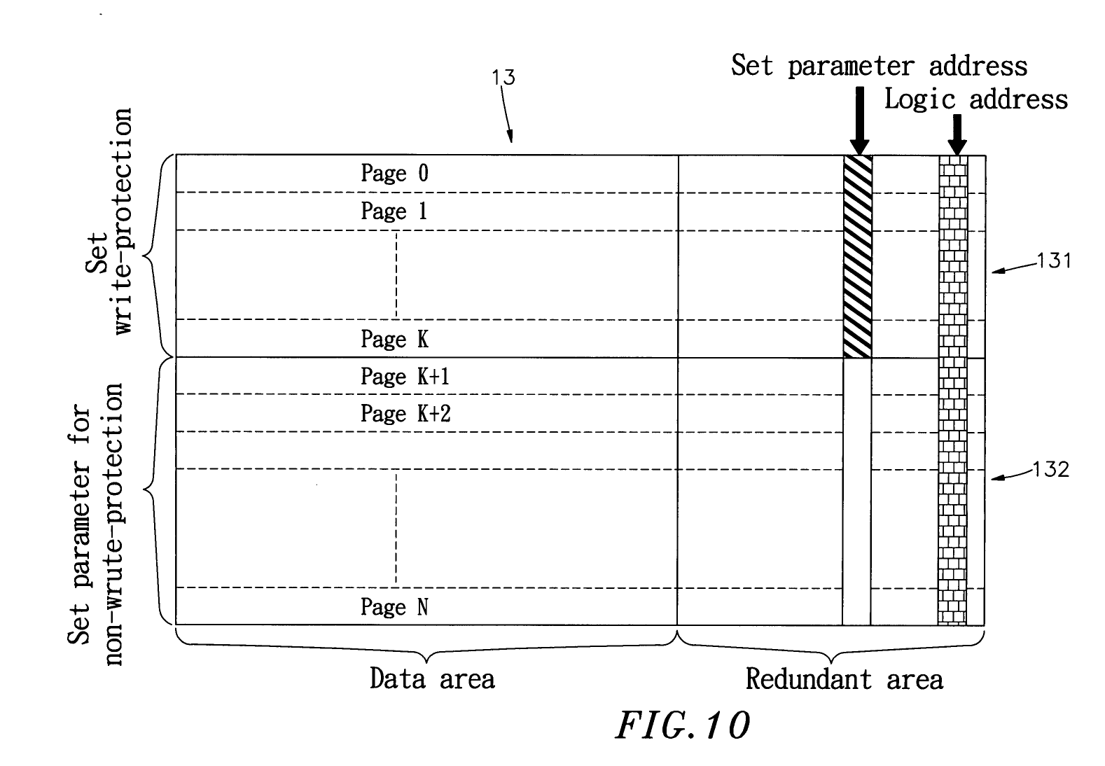

Referring to FIG. 9, taking the 32 MB (or 256 M bit) flash memory as an example, the flash memory 13 can be a NOR Type Flash memory, a 32 MB NOR Type Flash memory has 2048 blocks, and each block contains 32 pages; the page is the smallest data transmission unit, and a page is consisted of a 512 byte data area and a 16 byte redundant area. The arrangement is as following:
the redundant area, byte 0-511512-527, for storing data, logic address, block status, error parameter, the write-protection capacity is 512 Byte/16 Byte, therefore, when the single chip flash memory controller 12 writes the timeline/sequential into the data area and the redundant area, shown as FIG. 2, taking a 32 MB Nor Type Flash as the example, when the single chip flash memory controller 12 receives the writing command for writing into every pages, the writing procedure begins to write into the data area and also reads whether or not the redundant area has the write-protection parameter, if the write-protection parameter exists then the writing command can not be executed. As shown in FIG. 10, on the left hand side of the flash memory 13 is the data area and the right side is the redundant area, the upper part is block 0 131, has write-protection, and the lower part is block 1 132, has no write-protection.

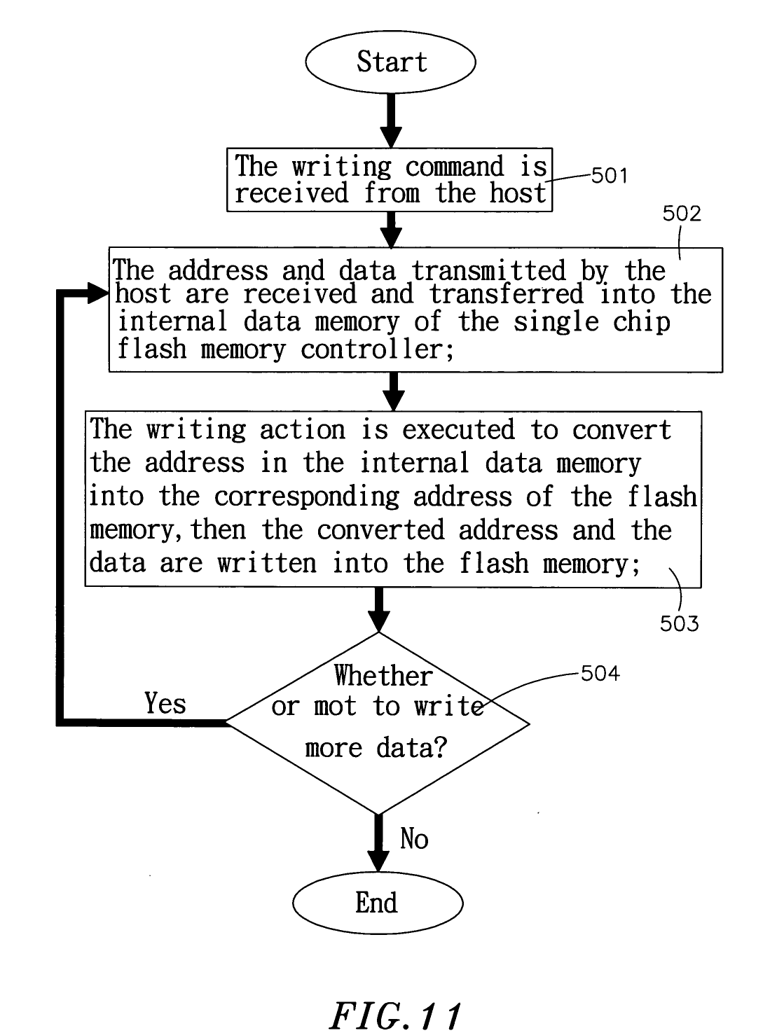

Referring to FIGS. 8 and 11, in this embodiment, the single chip flash memory controller 12 writes data into the flash memory 13 through the data transmission wire 16 connected to the flash memory 13. When the memory device 1 processes writing action, the procedure of the single chip flash memory controller 12 is described as follows:
the writing command is received from the host 15 (step 501);
the address and data transmitted by the host 15 are received and transferred into the internal data memory 151 of the single chip flash memory controller 12 (step 502);
the writing action is executed to convert the address in the internal data memory 151 into the corresponding address of the flash memory 13, then the converted address and the data are written into the flash memory 13 (step 503);
whether to write more data is judged (step 504), if yes, then the procedure proceeds to step (502), if not, the procedure ends.

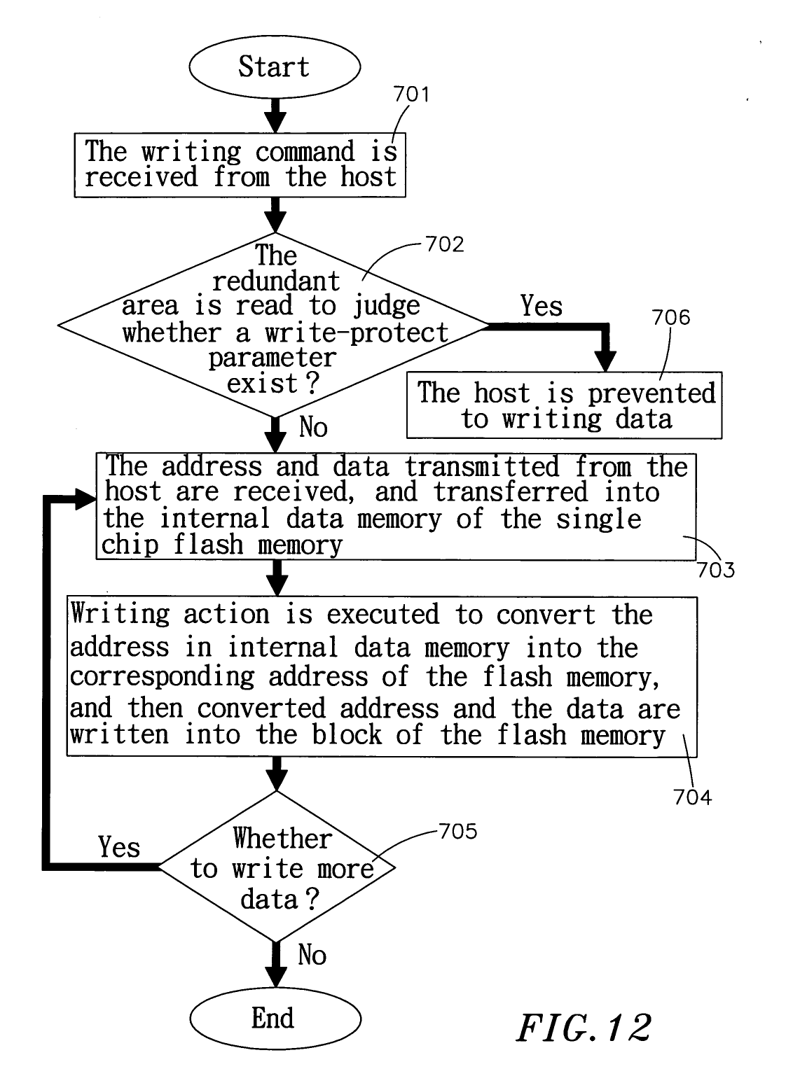

Furthermore, referring to FIG. 12, when the redundant area is set for having the write-protect parameter and the host 15 stores/retrieves data or program to/from the flash memory 13, the procedure of the single chip flash memory controller 12 is described as follows:
the writing command is received from the host 15 (step 701);
the redundant area is read to judge whether a write-protect parameter exist (step 702), if yes, the procedure proceeds to step (706), if not, the procedure continues to the following step (703);
the address and data transmitted from the host 15 are received, and transferred into the internal data memory 151 of the single chip flash memory controller 12 (step 703);
writing is executed to convert the address in the internal data memory 151 into the corresponding address of the flash memory 13, and then the converted address and the data are written into the block 1 132 of the flash memory 13 (step 704);
whether to write more data is judged (step 705), if yes, then the procedure proceeds to step (703), if not the procedure ends;
the host 15 is prevented from storing data into the block 0 131 in response to the host 15 (step 706).

As described above, by including a write-protect parameter in the redundant area of the flash memory 13, modification of the hardware structure or circuit connection of the memory device 1 is not required, but rather by merely setting up or renewing the write-protect parameter into the single chip flash memory controller 12 to mark any block, the data or program therein can be substantially protected. In the above two embodiments of the present invention, the interface circuit 11 can be a USB, PCMCIA or ATAIDE interface.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A write-protected micro memory device, comprising:
a single chip flash memory controller, having a write-protect parameter;
at least one flash memory divided into one or multiple blocks, connecting to said single chip flash memory controller, wherein said write-protect parameter is marked to write-protect a block of said flash memory; and
an interface circuit, connecting to said single chip flash memory controller, and a host connected between said memory device and said host;
wherein when said host retrieves/stores data or program from/to said flash memory, said single chip flash memory controller can prevent said host to write data into said marked block in the flash memory according to said preset write-protect parameter.

2. The write-protected micro memory device according to claim 1, wherein said single chip flash memory controller is a programmable firmware, which is inlayed in or external to a mask ROM, wherein a program or data recorded once in said mask ROM to enable the user to set said write-protect parameter, and said parameter has a write-protection to said marked block.

3. The write-protected micro memory device according to claim 1, wherein said single chip flash memory controller is a programmable firmware, which is inlayed in or external to a rewriteable memory, wherein a program or data recorded once in said rewriteable memory to enable the user to set said write-protect parameter, and said parameter has a write-protection to said marked block.

4. The write-protected micro memory device according to claim 3, wherein said rewriteable memory is comprised of EEPROM or Nor Type Flash.

5. The write-protected micro memory device according to claim 1, wherein said interface circuit is comprised of an USB interface circuit, PCMCIA or ATA IDE interface.

6. The write-protected micro memory device according to claim 1, wherein said single chip flash memory controller is to convert a control signal of said host into a signal for controlling said flash memory, and to manage and program properly for said flash memory to make said single chip flash memory controller receiving a command from said host (including writing address and data), and send out said writing command to said flash memory then write said address and data transmitted from said host 15 in orderly into said flash memory.

7. The write-protected micro memory device according to claim 1, wherein said memory device is comprised of a memory card.

8. The write-protected micro memory device according to claim 1, wherein said memory device is comprised of a memory stick.

9. The write-protected micro memory device according to claim 1, wherein said host is comprised of a computer.

10. The write protected micro memory device according to claim 1, wherein said host is comprised of a card reader.

11. A write-protected micro memory device, comprising:
an interface circuit, connecting to a host;
at least one flash memory, divided into one or multiple blocks, comprising a redundant block having a write-protect parameter; and
a single chip flash memory controller, connecting to said interface circuit and said flash memory respectively;
wherein when said host retrieves/stores data or program from/to said flash memory, said single chip flash memory controller can prevent said host to write data into said marked block in the flash memory according to said preset write-protect parameter.

12. The write-protected micro memory device according to claim 11, wherein said flash memory is comprised of a 32 MB NOR Type Flash, said 32 MB NOR Type Flash has 2048 blocks, and each block contains 32 pages; a page is a smallest data transmission unit, and said page is consisted of a 512 byte data area and a 16 byte redundant area.

13. The write-protected micro memory device according to claim 11, wherein said interface circuit is comprised of an USB interface circuit, PCMCIA or ATA IDE interface.

14. The write-protected micro memory device according to claim 11, wherein said memory device is comprised of a memory card.

15. The write-protected micro memory device according to claim 11, wherein said memory device comprised of a memory stick.

16. The write-protected micro memory device according to claim 11, wherein said host is comprised of a computer.

17. The write protected micro memory device according to claim 11, wherein said host is comprised of a card reader.
